(19) United States
(12) Patent Application Publication
(10) Pub. No.: US 2014/0167947 A1
(43) Pub. Date: Jun. 19, 2014

(54) PHYSICAL POINTER OVER FLAT DISPLAY VEHICLE INSTRUMENT PANEL

(71) Applicant: continental Automotive Systems, Inc., Auburn Hills, MI (US)

(72) Inventors: Vyacheslav B. Birman, Auburn Hills, MI (US); Arthur S. Brown, Sterling Heights, MI (US)

(73) Assignee: Continental Automotive Systems, Inc., Auburn Hills, MI (US)

(21) Appl. No.: 14/082,452

(22) Filed: Nov. 18, 2013

Related U.S. Application Data
(60) Provisional application No. 61/738,429, filed on Dec. 18, 2012.

(51) Int. Cl. B60Q 1/00

(52) U.S. Cl. CPC B60Q 1/00
USPC 340/441; 340/438

(57) ABSTRACT

A disclosed vehicle instrument panel assembly includes a display disposed within a first plane and configured for generating an image indicative of vehicle operation and a pointer disposed on a second plane spaced apart from the first plane and extending at least partially over the display to highlight the image generated by the display.

### CROSS REFERENCE TO RELATED APPLICATION

This application claims priority to U.S. Provisional Application No. 61/738,429 filed on Dec. 18, 2012.

### TECHNICAL FIELD

The present disclosure relates to vehicle instrument panels and clusters, and more specifically to a vehicle instrument panel that includes physical features cooperating with images displayed on a display.

### BACKGROUND

Vehicles include instrument panels to communicate information indicative of operation to an operator. Motor vehicles include instrument panels with several gauges and dials that communicate vehicle conditions such as speed, engine rpm, temperature, oil pressure along with many other operational parameters. Conventional instrument panels include gauges that may only provide one piece of information such as a speedometer.

Flat screen displays are increasingly being utilized and are capable of providing different information within the same space. For example, a single display can be utilized to display vehicle speed in one moment, and then changed to display a map, engine rpm or other desired parameter indicative of vehicle operation. The flat screen displays allow a vehicle designer to provide more information within a fixed area of the instrument panel.

Although a flat screen display provides many different possible display combinations, it limits the aesthetic appearance of the instrument panel because although the display itself may provide different images, the physical appearance can be uninteresting and limit design alternatives. Moreover, three-dimensional effects can be displayed on the display but are limited to the graphics generated by images on the display.

Accordingly, it is desirable to design and develop an instrument panel that includes a flat panel display with features that add both increased functionality while providing desired three-dimensional appearance and effects.

### SUMMARY

A vehicle instrument panel assembly according to an exemplary embodiment of this disclosure, among other possible things includes an instrument display that includes an electronic display screen to generate images indicative of vehicle operating parameters and conditions and a pointer that extends over the display to point to a graphic illustrated on the display screen.

The example instrument display includes a display screen that generates images indicative of vehicle operating conditions and parameters. The example display screen is divided into a central portion, a first side and a second side. Images generated by the display represent a moving scale that moves relative to a fixed pointer. The pointer is fixed relative to the display screen and extends over a portion of display and onto the generated visually moving display. In one example, the moving scale is vehicle speed and the pointer highlights current vehicle speed shown on the display. Another portion of the display generates a tachometer and a second pointer indicates a current engine rpm.

The combination of generated moving scales on the fixed display screen combined with the physical pointer generates a desired geometrical and 3-D appearance of the example instrument display that provides a different appearance and aesthetically pleasing effects while also generating and communicating functional information to a vehicle operator.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example vehicle dashboard and instrument panel.

FIG. 2 is a front view of the example vehicle instrument display.

FIG. 3 is a perspective view of the example vehicle instrument display.

FIG. 4 is an enlarged view of a portion of the example vehicle instrument display.

FIG. 5 is a cross-sectional view of a portion of the example vehicle instrument display.

### DETAILED DESCRIPTION

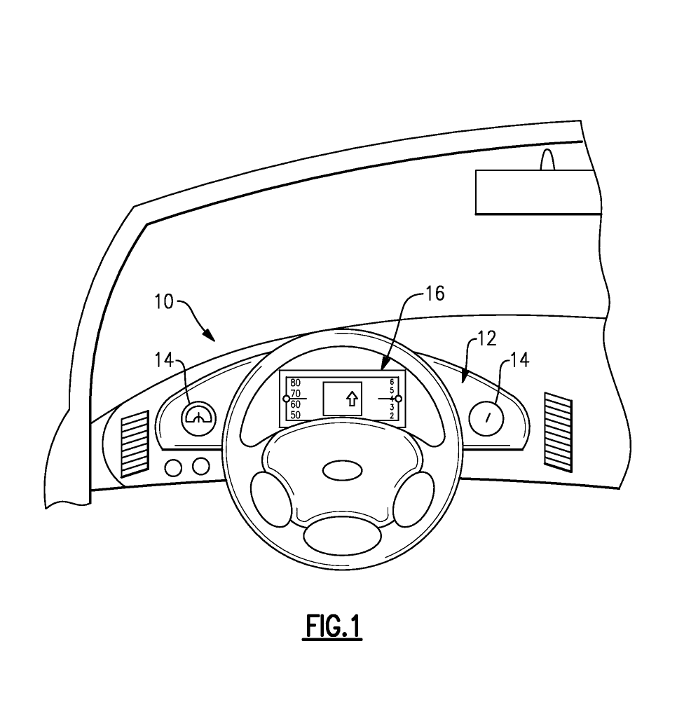

Referring to FIG. 1, a vehicle dashboard 10 is shown and includes an instrument panel 12 that includes an instrument display 16 and other accessory gauges 14. The example instrument display 16 utilizes an electronic display screen to generate images indicative of vehicle operating parameters and conditions.

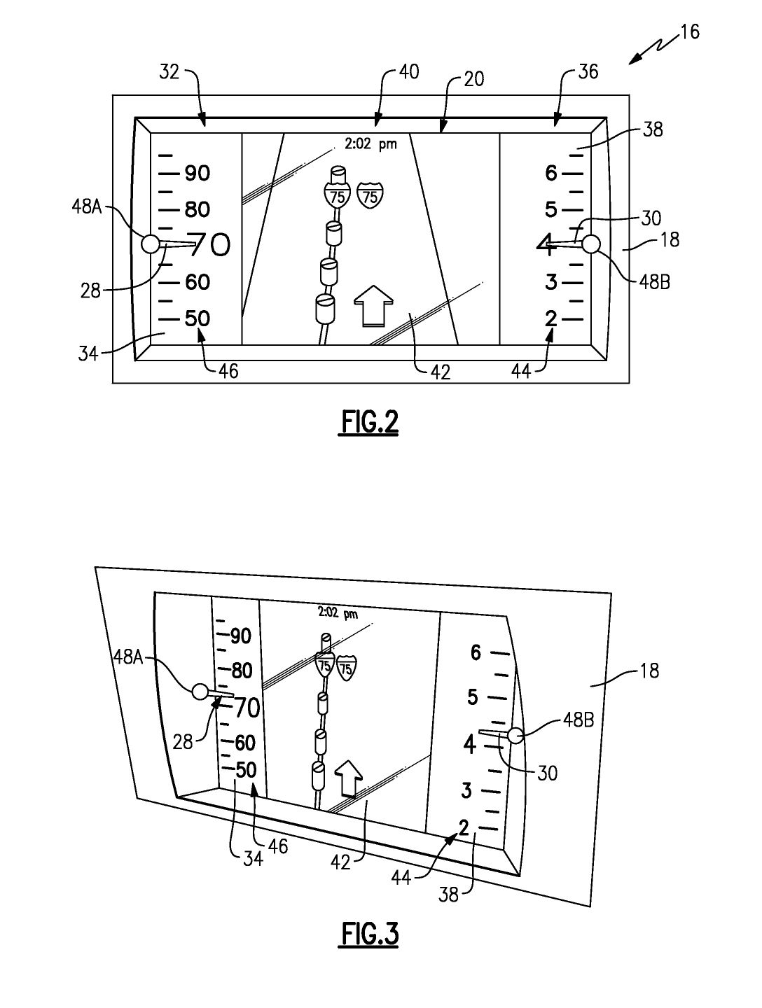

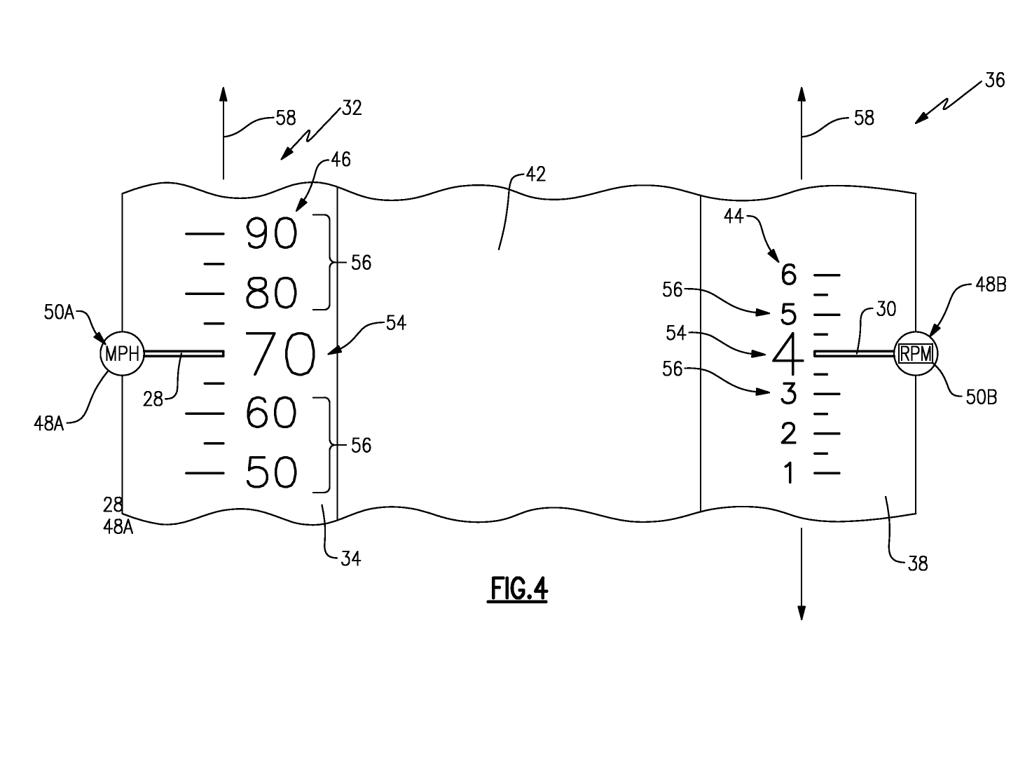

Referring to FIGS. 2 and 3 with continued reference to FIG. 1, the example instrument display 16 includes a display screen 20 that generates images indicative of vehicle operating conditions and parameters. The example display screen 20 is a liquid crystal display or other flat display that is capable of generating images representing information that is communicated to a vehicle operator. As appreciated, instrument panels are typically comprised of dial gauges or other gauges that provide a fixed scale about which a pointer rotates to indicate a specific operating parameter. Such gauges are limited in that they are fixed and can only display one type of information. Accordingly, the use of digital displays is becoming increasingly popular and provides the ability to display different parameters and provides communication of a significant amount of information to an operator within a limited space.

The example instrument display 16 includes the display screen 20 that is divided into a central portion 40, a first side 32 and a second side 36. The first side 32 generates a first image 34, the second side 36 generates a second image 38 and the central portion 40 is capable of displaying a central image 42. As appreciated, although three separate images are disclosed for the example display screen 20 other configurations would also fall within the contemplation of this disclosure.

In this example, the first side 32 generates an image 34 that is indicative of a vehicle speed. The second side 36 generates an image 38 that is indicative of engine rpm. The central portion 40 generates an image in this example that provides directional information such as is provided by a GPS guidance system.

The first image 32 represents a moving scale that moves relative to a fixed pointer 28. The pointer 28 is fixed relative to the display screen 20 and extends over a portion of display that is provided by the first side 32. The first image 34 is an image that is generated to replicate a moving scale. In this example, the moving scale is vehicle speed and the specific current operating condition or vehicle speed in this instance is indicated by the pointer 28.

The combination of the pointer 28 extending over the first side 32 of the display screen and first image 34 provides a three dimensional effect to replicate movement of the scale as if it were rotating on a cylindrical surface. Replication in this disclosure is utilized to represent an image displayed on the fixed display screen 20 that creates the impression of a physically moving scale.

The second image 38 also replicates an image of a moving scale. The example second image 38 moving scale is of engine speed in rpm. As with the first image 34, the second image 38 replicates moving scale as if it were rotating vertically on a cylindrical surface and a second pointer 30 extends over the second side 36 to provide a focus point on the second image 38 that cooperates to indicate a current value for engine rpm.

The display screen 20 is disposed within a housing 18 that supports the first and second fixed pointers 28, 30. Each of the first and second pointers 28, 30 include a cap 48A, 48B. The caps 48A and 48B are also fixed to the housing 18 and do not move relative to the display screen 20.

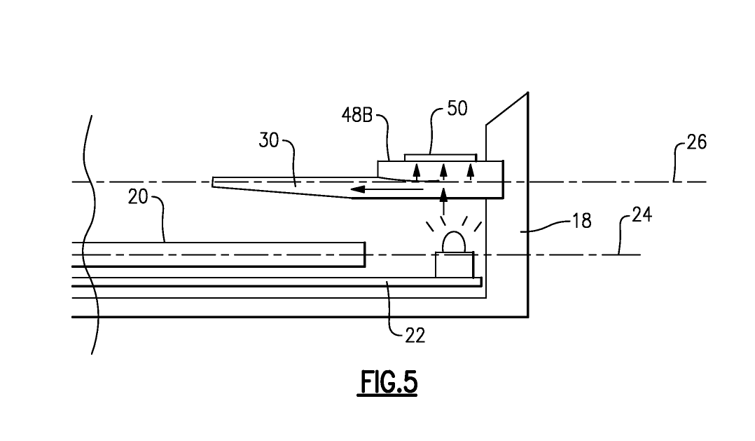

Referring to FIGS. 4 and 5, the display screen 20 is disposed on a first plane 24 and the first and second pointers 28, 30 are disposed on a second plane 26. In the example illustrated in FIG. 4, only the second side 36 is shown. The second plane 26 is spaced apart from the first plane 24 and is closer to the vehicle operator than the display screen 20. The relative distance between the first plane 24 and the second plane 26 creates a three dimensional effect that corresponds with the moving scale provided by the first and second images 34, 38.

In the disclosed example, the moving scale replicates a movement of a cylindrical surface in a vertical direction about an axis parallel with the first and second planes 24, 26. In this example, the graphic images of the numerals increase in size as they move closer to the location indicated by the corresponding first and second pointers 28, 30.

In this example, the graphic images are reference numerals within the first and second images 34, 38 and increase in size as is indicated at 54 when generated at a location corresponding with the corresponding pointer 28, 30. As the reference numeral is generated to visually move away from the location indicated by the pointer 28, 30, they become smaller in size as is indicated at 56. The increase in size of the reference numeral as shown at 54 highlights the current value of the operating parameter to a vehicle operator and increases the ability to monitor vehicle operating conditions with only short glances at the instrument display 16.

Caps 48A and 48B are disposed over the corresponding pointer 28, 30 and include a corresponding graphic 50A and 50B. The graphics 50A and 50B may be illuminated to indicate the specific scale that is being disclosed and generated by the display screen 20 on the corresponding side. As appreciated, the display screen 20 may be modified to display other vehicle operating parameters and, therefore, the pointer caps 48A; 48B can be illuminated to indicate which vehicle parameter is being represented by the first and second images 34, 38.

A printed circuit board 22 is supported within the housing 18 and includes a light source 52. The light source 52 emits light into the second pointer 30 and the cap 48B. The illumination provided by the light source 52 can be utilized to illuminate both the second pointer 30 and the pointer cap 48B. In this example, the pointer cap 48B includes a graphic 50 that is illuminatable to indicate the specific scale being displayed within the second image 38. In this example, the second image 38 is providing a scale indicative of an engine rpm. Accordingly, the graphic 50 may be illuminated to indicate that the scale is engine rpm.

The characteristics and physical, geometrical and actual 3-D effects provided by the example instrument display 16 provides a different appearance and aesthetically pleasing effects while also generating and communicating functional information to a vehicle operator.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A vehicle instrument panel assembly comprising:
a display disposed within a first plane and configured for generating an image indicative of vehicle operation; and
a pointer disposed on a second plane spaced apart from the first plane and extending at least partially over the display to highlight the image generated by the display.

2. The vehicle instrument panel assembly as recited in claim 1, wherein the display is configured to generate a first image on a first side of the display, a second image on a second side of the display and a central image in a central portion of the display between the first and second images.

3. The vehicle instrument panel assembly as recited in claim 2, wherein the pointer comprise a first pointer extending over the first image of the display and a second pointer extending over the second image of the display.

4. The vehicle instrument panel assembly as recited in claim 2, wherein at least one of the first image and the second image replicate numerals rotating vertically on a cylindrical surface.

5. The vehicle instrument panel assembly as recited in claim 4, wherein the first image generates numerals indicative of vehicle speed.

6. The vehicle instrument panel assembly as recited in claim 4, wherein the second image generates numerals indicative of engine rpm.

7. The vehicle instrument panel assembly as recited in claim 1, wherein the pointer includes a cap with illuminatable graphics indicating the operating parameter that the pointer is highlighting.

8. The vehicle instrument panel assembly as recited in claim 7, wherein the pointer and cap are illuminatable by a common light source.

9. The vehicle instrument panel assembly as recited in claim 1, including tell tales disposed on at least one side of the display that correspond with images generated by the display.

10. The vehicle instrument panel assembly as recited in claim 1, wherein the generated image includes a reference character that increases in apparent size corresponding to a proximity to location of the pointer.

11. The vehicle instrument panel assembly as recited in claim 2, wherein the central image comprises directional information provided to a vehicle operator.

12. A method of communicating information to an operator of a motor vehicle comprising:
generating an image representing a parameter indicative of vehicle operation on a display screen; and
indicating a current value of the parameter indicative of vehicle operation with a fixed pointer extending over the display.

13. The method as recited in claim 12, including generating the image representing a parameter indicative of vehicle operation as a moving scale on the display and coordinating movement of the moving scale to a location of the fixed pointer to indicate the current value of the parameter indicative of vehicle operation.

14. The method as recited in claim 13, including mounting the display on a first plane and mounting the fixed pointer on a second plane different than the first plane.

15. The method as recited in claim 13, including generating the moving scale as a reference numerals rotating vertically on a cylindrical surface.

16. The method as recited in claim 15, including generating the reference numerals to increase in apparent size corresponding to the location of the fixed pointer.

17. The method as recited in claim 13, including illuminating an image on a cap proximate the pointer to communicate units of the moving scale.

18. The method as recited in claim 13, including generating a first image on a first side of the display screen comprising a first moving scale indicative of vehicle speed and a second image on a second side of the display screen comprising a second moving scale indicative of engine rpm and indicating with a first pointer on the first moving scale and a second pointer on the second moving scale.
